(19) United States
(12) Patent Application Publication
(10) Pub. No.: US 2008/0167175 A1
(43) Pub. Date: Jul. 10, 2008

(54) Refractory Melt Barrier For In-Container Vitrification

(76) Inventors: Patrick S. Lowery, Kennewick, WA (US); Leo E. Thomason, Kennewick, WA (US); Brett E. Campbell, Richland, WA (US); Steven L. Woosley, Pasco, WA (US)

Correspondence Address: KLARQUIST SPARKMAN, LLP, 121 SW SALMON STREET, SUITE 1600, PORTLAND, OR, 97204, US

(21) Appl. No.: 11/883,276

(22) PCT Filed: Jan. 27, 2006
(86) PCT No.: PCT/US06/02969

§ 371 Date: Jul. 27, 2007

Related U.S. Application Data
(60) Provisional application No. 60/647,984, filed on Jan. 28, 2005.
(60) Provisional application No. 60/648,108, filed on Jan. 28, 2005.
(60) Provisional application No. 60/648,112, filed on Jan. 28, 2005.
(60) Provisional application No. 60/648,166, filed on Jan. 28, 2005.
(60) Provisional application No. 60/648,161, filed on Jan. 28, 2005.

(51) Int. Cl. C03B 5/43; C04B 35/00

(52) U.S. Cl. 501/127; 501/94

(57) ABSTRACT

A process for melting material to be treated includes placing material to be treated in a container that may include an insulating lining, heating the material to be treated and melting the material to be treated, preferably allowing the melted material to cool to form a vitrified and/or crystalline mass, and disposing of the mass. The mass is either disposed while contained in container or removed from container after cooling and disposed. The insulating lining may comprise one or more layers of a thermal insulating material, one or more layers of refractory material, or a combination thereof.

This application claims the benefit of priority to copending U.S. provisional applications 60/648,161 (attorney docket number 14664-B), 60/648,108 (attorney docket number 14665-B), 60/648,112 (attorney docket number 14666-B), 60/647,984 (attorney docket number 14667-B), and 60/648,166 (attorney docket number 14669-B), each of which are incorporated herein by reference.

### FIELD OF THE INVENTION

The present invention relates to vitrification of waste materials. More specifically, the invention relates to a refractory melt barrier for use with in-container vitrification.

### BACKGROUND

Several vitrification methods for safely disposing contaminated soil or waste materials (hereinafter referred to as material to be treated) are known in the art. Examples of such methods are provided in U.S. Pat. Nos. 4,376,598; 5,024,556; 5,536,114; 5,443,618; and, RE 35,782.

Generally, some of the known vitrification methods involve placement of a material to be treated into a vitrification chamber or vessel having electrodes and an electrically conductive resistance path, known as a starter path, between the electrodes. A current is supplied to the starter path through the electrodes. Through joule heating, the current increases the temperature of the starter path to the point where the adjacent material to be treated begins to melt. Once the heating is initiated and melting of the material begins, the molten material itself becomes electrically conductive and can continue current conduction and joule heating. Application of power to the electrodes can continue until the desired amount of material is completely melted.

In the course of melting, the contaminants present in the melting vessel are either destroyed or removed by the high temperature, or they become part of the melt and the resulting vitrified product upon cooling. Typically, for waste treatment applications, organic components and any other types of vaporizable materials (e.g., water) are destroyed or vaporized by the high temperature of melting and removed as gases which are routed through a suitable scrubber, quencher, filter or other known device(s) for purposes of ensuring that they are clean and suitable for environmental release. Inorganic materials (e.g., metal oxides) can become part of the melt and the resulting vitrified product wherein they are physically and/or chemically bound within the material, thus rendering them environmentally safe.

Once the material is sufficiently melted and all contaminants are treated, the electricity supply is terminated and the molten material is allowed to cool. The cooling step then results in a vitrified and/or crystallized solid material. In this manner, inorganic contaminants are securely immobilized or contained within a solid, vitrified mass thereby facilitating disposal of same.

In most of the known methods, continuous vitrification is performed within a complex refractory lined melting apparatus, and batch vitrification is performed either in situ or within a pit dug in the ground. In continuous vitrification, some of the molten material can be continuously or periodically withdrawn while more material to be treated is simultaneously or periodically added. In contrast, batch vitrification can be completed and terminated once the full amount of material to be treated has been melted.

One known vitrification apparatus comprises a chamber that is either permanently in place (as in a treatment facility) or that can be dismantled and reassembled at desired locations. In each case, the molten mass is removed from the chamber and processed further separately. Such further processing may involve burial, or other type of disposal, of the vitrified and/or crystalline mass. The apparatus known in the art for conducting continuous vitrification processes are normally complex structures including a refractory lined melting vessel, various electrical supply systems, waste feed systems, molten glass discharge systems, cooling systems and off-gas treatment systems. Such systems require the removal of the melted mass while in the molten state, hence requiring the above mentioned molten glass discharge systems. In these cases, the melt is either poured or flowed out as a molten material into a receiving container.

Onsite processes such as in-situ vitrification (ISV) and staged earth melting have also been previously described. In staged earth melting, the material to be treated is placed into a pit or trench in the ground and a soil or other type of cap is placed as a cover. Electrodes are then introduced to conduct the vitrification process in a manner similar to the one described above. Alternatively, in ISV, the material to be treated, which is typically contaminated soil, remains undisturbed except as required to emplace the electrodes. Once the processes are completed, the vitrified and/or crystalline mass is left buried in the ground at the treatment site, or it can be removed, if desired, for land use concerns. As will be appreciated, certain contaminants such as radioactive waste, for example cannot be disposed in this manner unless the treatment is performed in a regulated burial location.

Generally, the known methods are limited to onsite applications or by the requirement for complex, expensive melters. Therefore, there exists a need for a vitrification apparatus and method that overcomes these and other limitations.

### SUMMARY OF THE INVENTION

In-container vitrification (ICV) is a batch process for melting a material to be treated and generally comprises the following exemplary steps:
placing the material to be treated into a disposable container;
heating the material to be treated in the container until it melts to create melted material; and
allowing the melted material to cool in the container to create a solidified material.

The material to be treated can be (a) contaminated soil, such as soil containing radioactive or non-radioactive contaminants, (b) hazardous materials of most types, (c) any waste material that requires thermal or vitrification treatment, or (d) mixtures or combinations of such materials. The material to be treated can be heated using at least two electrodes positioned in the material to be treated and passing a current between the electrodes (or passing heat from the heating element), and hence through the material to be treated. The current and/or heating element heats the material to be treated and causes it to melt sufficiently for the melted material to form a solidified vitreous and/or crystalline mass after it is allowed to cool. The solidified material may be disposed while it is within the container (i.e., the material and container are both disposed) or may be disposed after it cools by removing it from the container and appropriately disposing of the solidified material, thus enabling the container to be reused.

The present invention encompasses a melt barrier comprising earthen material for controlling the shape and growth of a waste-containing melt. The melt barrier physically prevents the molten waste/soil from contacting the container wall, which could cause the container to fail.

The present invention also encompasses a melt barrier comprising a mixture of earthen material and a binder to stabilize the earthen material for ease of handling.

The present invention further encompasses a melt barrier comprising a mixture of earthen material and an insulating material.

Still further, the present invention encompasses an overburden material that attenuates heat loss and melt-surface disruption events by covering at least a portion of an exposed surface of the melt.

The present invention also encompasses a method for feeding additional material into the container during melting.

The present invention further encompasses an apparatus providing rapid melt-startup during ICV comprising a plurality of starter paths.

The present invention still further encompasses a method for treating waste products comprising mixing the waste product with earthen material and vitrifying the mixture.

It is an object of the present invention to provide enhancements to vitrification, and especially ICV, thereby increasing the efficiency and cost-effectiveness of waste treatment through vitrification.

Another object of this invention is to provide a treatment vessel for in-container vitrification generally comprising a thermally insulating layer in contact with the interior of the treatment vessel and a layer of refractory materials in thermal contact the insulating material, which is interposed between the insulating layer and the material to be melted.

An additional objective is to provide a “roll-off box” or other simple enclosure as the melting treatment vessel or treatment vessel. Another objective to use a standard waste box to hold the material for melting. It is still another objective that the treatment vessel has at least one removable wall for the purpose of assisting in the removal of vitrified product from the treatment vessel after the in-container vitrification process.

It is still another objective that the treatment vessel has at least one small portion of a wall that can be removed to allow draining of molten material, and then replaced.

Another objective of this invention is to use carbon-based materials as an insulating and refractory layer, which layer may also be employed as an electrically conductive electrode surface.

Further still, another objective is to use Duraboard and similar insulating materials as an insulating layer.

Yet another objective is to employ an air gap as an insulating layer.

Yet another objective is to employ natural earthen materials such as high silica-content sand, gravel and/or cobble rock as insulating and/or refractory materials for the subject layers.

A yet still another objective of this invention is to use carbon based materials as an insulating layer or other insulating materials such as, for example, graphite based materials.

Yet another objective is to use Thermotect Board Insulation as an insulating layer.

### BRIEF DESCRIPTION OF THE DRAWINGS

These and other features of the preferred embodiments of the invention will become more apparent in the following detailed description in which reference is made to the appended drawings wherein:

FIG. 1 is a diagram of an ICV container having multiple starter paths.

FIG. 2 is a diagram of an ICV container having multiple starter paths and an electrode sheath.

FIG. 3 is a diagram of starter path configurations.

FIGS. 4a and 4b are diagrams showing passive and active feeding of additional material to be treated, respectively.

FIG. 5 is an end cross sectional elevation view of a container according to an embodiment of the present invention.

FIG. 6 is an end cross sectional elevation view of an apparatus including the container of FIG. 1 when in use according to an embodiment of the invention.

FIG. 7 is an end cross sectional elevation view of an apparatus including the container of FIG. 1 when in use according to another embodiment of the invention.

FIG. 8 illustrates a cross-section view of the treatment vessel;

FIG. 9 illustrates a perspective view of the treatment vessel wherein the treatment vessel that has at least one sidewall which is pivotally hinged to allow the treatment vessel to partially open to facilitate a slower a slower drain of the melt.

FIG. 10 illustrates another perspective view of the treatment vessel wherein the sidewall may be completely open to allow for easy disposal of the melt material.

FIGS. 11a to 11d are cross-sectional, elevation, end views of the apparatus of FIG. 3 in various stages of the melting process of the invention.

### DETAILED DESCRIPTION

As discussed above, traditional vitrification processes have typically been conducted in situ, in pits, or in complex engineered melting chambers. The present invention, however, provides a container into which the material to be treated is placed and in which the melting process is conducted. Moreover, the container is manufactured in such as a manner as to be low in cost and easily disposable once the melting process is completed. This avoids the need to remove and handle the vitrified and/or crystalline mass, thereby providing a safe and easy means of waste disposal.

The container of the present invention may be used in conjunction with most types of vitrification processes. By example, and not to be limiting, the container of the present invention may be used with any material that can be melted and any material that can be treated by exposure to molten inorganic materials. The container and process may be used for various contaminant types such as heavy metals, radionuclides, and organic and inorganic compounds. Concentrations of the contaminants can be of any range suitable for vitrification. Further, the invention can be used with naturally-occurring earthen materials, or soil. The types of soils can include, for example, sand, silt, clay, sediment, gravel, cobble, rock, boulders, and combinations thereof. The material types may be wet or comprise sludges, sediments, or ash.

### Configuration of Starter Paths and Electrodes

The general melting process can involve joule-heated electric melting of materials to be treated, such as contaminated soil or other earthen materials for purposes of destroying organic contaminants and immobilizing hazardous inorganic and radioactive materials within a high-integrity, vitrified and/or crystalline product. Electric melting may occur using different types of heating processes such as joule heating and plasma heating. The process is initiated by placing at least two electrodes, or at least one heating element, within the material to be treated, followed, optionally, by placement of a conductive starter path material between at least two electrodes. When electrical power is applied, current flows through the starter path, heating it sufficiently enough to melt the adjacent soil. When the soil, which can be contaminated with a waste, becomes molten, it becomes electrically conductive, and from that point on, can serve as a heating element for the process. Heat is conducted from the molten mass into adjacent un-melted materials, heating it to the melting point, after which time it too becomes conductive. The process continues by increasing the amount of material melted until the supply of electric power is terminated. During the melting process, any off gases are captured and, where necessary, treated in a known, suitable manner. The solidified mass comprises a vitrified and/or crystalline product. The vitrification process immobilizes, destroys, and/or vaporizes contaminants including, but not limited to organics, heavy metals and radionuclides. The melting process has a high tolerance for debris such as, for example, steel, wood, concrete, boulders, plastic, bitumen, and tires.

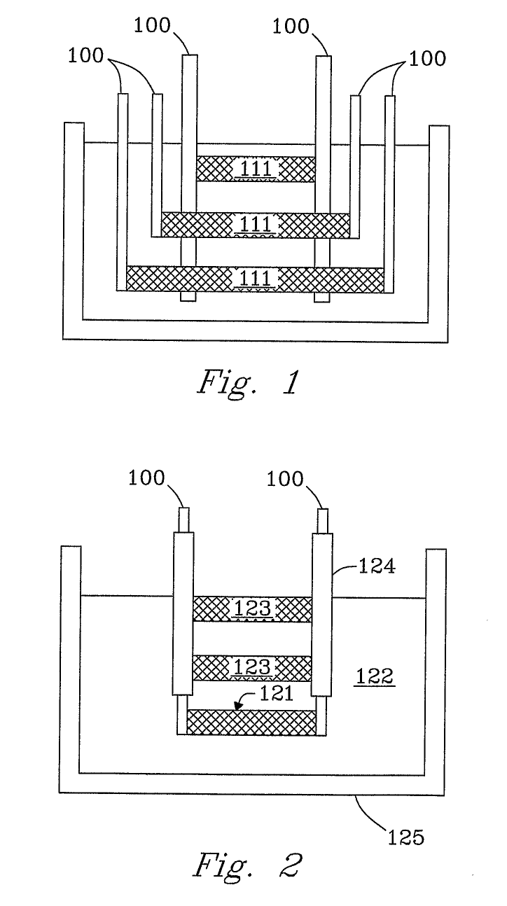

The time required for startup of the melting procedure can be reduced by utilizing multiple starter paths. Since creating an initial melt zone can require a significant portion of the total heating time, minimization of start-up times can significantly reduce the total time required for vitrification by maximizing the amount of melt surface area that is available to heat adjacent unmelted material. For example, referring to FIG. 1, a plurality of starter paths 111 can provide rapid startup of the in-container vitrification process by initiating melt zones in multiple locations throughout a container. In one embodiment of the present invention, the starter paths electrically contact electrodes 100 connected to at least one power supply. The electrodes 100 can be connected to one or more power supplies. If using a single power supply, power can be alternately applied through at least two electrodes at one time. Alternatively, a plurality of power supplies can be used to supply power to a subset of dedicated electrodes. For example, three power supplies can be used with six electrodes, wherein each power supply is independently connected to a pair of electrodes. Alternatively, electric means can be used to divert power to any number of electrodes from any number of power supplies.

While the starter paths may be emplaced anywhere in the container, in one embodiment, at least one of the starter paths is in a relatively deeper region of the container such that the initial melt zone is generated in the bottom portion of the container and the primary direction of melt growth is toward the upper surface of the material to be treated. Referring to FIG. 2, a portion of the material to be treated 122 can be placed in the bottom of the container 125. A primary starter path 121 in the deeper region of the container can contact a pair of electrodes 100 and follow the contour of the bottom surface of the container 125. For example, the starter path can be substantially parallel to the bottom surface of the container. Additional starter paths 123 and material to be treated 122 can be placed in the remaining volume of the container. When current is applied through the primary starter path 121, the initial melting can occur uniformly in the bottom of the container and progress generally upward (i.e., bottom-up heating).

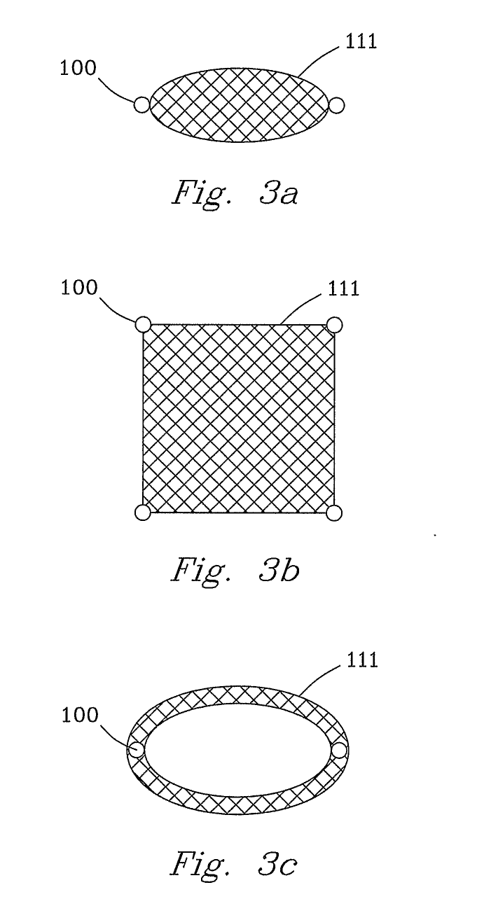

Referring to FIG. 3, the shape of the starter paths can be essentially linear (curved or straight) or planar. Vertical planar paths have been described in U.S. Pat. No. 6,120,430 and the content describing such paths is incorporated herein by reference. The plurality of starter paths can be selected from the group consisting of at least 2 linear paths, at least 2 planar paths, and at least one linear path with at least one planar path. Each of the starter paths can comprise a material selected from the group consisting of electrically conductive graphite flakes, sodium hydroxide, sacrificial resistance elements, chemical reagents, and combinations thereof.

In another embodiment of the invention, the electrodes can comprise regions that are selectively chargeable. For example, referring to FIG. 2, the electrode can further comprise an electrode sheath 124 configured to electrically shield a portion of the electrode 100, thereby preventing electrical contact with at least one of the multiple starter paths. The sheath can comprise an insulating material, such as a non-conducting ceramic, and in the instance that an electrode is operably connected to multiple starter paths, the sheath can serve to prevent electrical contact between the electrode and all but the selected electrode path(s). Furthermore, the sheath 124 may be moveable in a direction of the electrode to switch between the available starter paths. For example, three independent starter paths can be operably connected between two electrodes, which are electrically connected to a power supply. A ceramic sheath having an electrically-conductive contact can be placed around one of the electrodes.

The electrically-conductive contact should be similar in shape and size to the cross-section of one of the starter paths and can comprise any conductive material such as metals, inorganics and ceramics. Alternatively, the contact can simply be the absence of sheath material such that the electrode directly contacts the starter path. The sheath can insulate two of the starter paths while allowing current to flow through the third. Each of the independent starter paths can be selected by moving the sheath and, therefore, the electrically-conductive contact from one starter path to another. In another embodiment of the sheath, there is no electrically-conductive contact. Instead, the sheath can be incrementally removed to expose an electrode to various starter paths, thereby allowing conduction of the current.

### Use of Engineered Overburden

For typical, naturally-occurring soil materials, the melting process may be performed in the temperature range of about 1200° to 2000° C., depending primarily on the composition of the materials being melted. Chemical additives can be used to control the melt temperature to within a desired range. In typical melters, the higher the melt temperature, the more costly the melting process and equipment due in part to the reduction in melt-container lifetime and the increased power required to compensate for rapid heat loss. However, container heat-cycle lifetime is not a significant issue in ICV because the containers can be designed for single- or limited-use and can be constructed at a minimal cost. Furthermore, continuous processes typically operate for thousands of hours, while in one embodiment, ICV containers are in use for only tens of hours.

However, heat loss through the exposed, upper surface of the melt can be a source of significant inefficiency. Furthermore, gases generated during the vitrification process can cause surface disruptions as they pass through the melt. Therefore, in one embodiment of the present invention, an engineered overburden material covers at least a portion of the exposed surface of the melt, thereby attenuating heat loss. Furthermore, by placing a sufficient amount of overburden on top of the melt, melt-surface disruptions can be dampened by the weight of the overburden layer.

The overburden material can comprise an earthen material. It can also include engineered materials like a flat panel, concrete, or a refractory. In one embodiment, the overburden material has a melting point greater than or equal to that of the material to be treated. The earthen material can be mixed with other materials, for example, silica-containing soils, such that the mixture has a higher melting point than that of the earthen material alone. Alternatively, the overburden material can comprise non-natural additives including, but not limited to hollow spheres, insulating materials, and other engineered materials. In another embodiment, the overburden material comprises a waste material to be treated. In yet another embodiment, a heavy panel or weight of concrete is placed on top of a soil overburden.

By attenuating heat loss, the overburden material can enable the melt to more quickly reach the maximum temperature for a given power input level. Preferably, the overburden material can be gas permeable, thereby providing a preferential pathway for gas flow to the surface. The overburden material can further comprise a filter media for removal of substances entrained in the off gas that passes through the overburden material. The filter medium can be selected from the group consisting of physical- and chemical-filtration media.

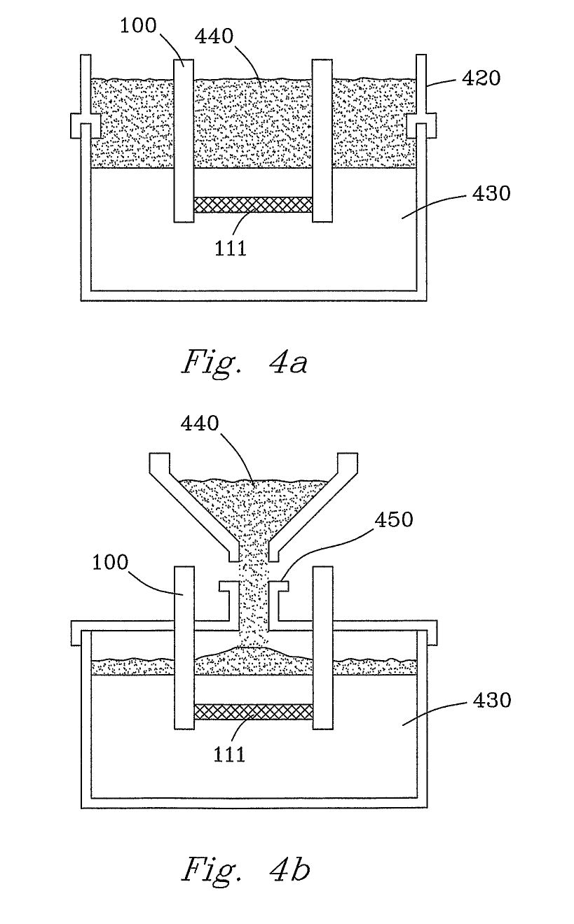

During the melting process, volume reduction generally occurs due to the densification of the material to be treated. Thus, in one embodiment of the present invention, additional material may be added to the container, using active or passive feeding methods, thereby maximizing the amount of material treated in each container. Referring to FIG. 4a, passive feeding occurs when additional material to be treated 440 is stored on top of the container prior to the start of the melting process. Temporary extension walls 420 can be used to contain the pre-loaded additional material to be treated prior to volume reduction. During the melting process, the melting of the material to be treated 430 results in the lowering of the additional material to be treated 440 into the container, and subsequently, the treatment of the additional material to be treated 440. Passive feeding can involve anticipating or measuring the amount of volume reduction to determine available volume after the initial loading has melted. A compensating amount of additional material to be treated can then be pre-loaded for passive feeding prior to starting the melt. During active feeding, referring to FIG. 4b, additional material to be treated 440 can be periodically or continuously added to the container through a feed port 450 in the hood during the melting process. Active feeding ceases when the container is essentially full. In both cases, the additional material can comprise the material to be treated and can serve as the overburden material. Alternatively, the additional material can comprise clean earthen material, insulating materials, engineering materials, and combinations thereof. Using the actively- or passively-fed additional material as an overburden can be particularly advantageous because the overburden material at the melt-overburden interface tends to be consumed as vitrification progresses. Thus, active feeding can serve the additional purpose of replenishing the overburden layer with the material being fed.

One method for using an overburden material for enhanced ICV can comprise providing a container lined with melt barriers and having a conductive starter path in a relatively deeper portion of said container as well as a plurality of electrodes electrically contacting the conductive starter path. The method can then involve filling at least a portion of the container with a first quantity of material to be treated, covering the exposed surface of said material to be treated with a first layer of overburden material, and then applying power to the electrodes, thereby starting the vitrification process. As the process progresses, some of the overburden can melt and be consumed. An additional amount of material to be treated can be actively or passively fed, which would then act as the overburden material for the growing melt, which minimizes melt surface disruptions. When the container is essentially full of molten material, power to the electrode is deactivated and the container is allowed to cool. The molten content solidifies into a solid monolith, thereby treating the waste contained therein.

### ICV Container Liner—Refractory Materials

In another embodiment of the present invention, the melting process involves the use of a steel container such as a commercially-available “roll-off box.” The inner sides of the container can be lined with an insulator to inhibit transmission of heat, and with a refractory material to protect the box during the melting process.

The refractory material serves as a melt barrier and can comprise earthen material such as rock, cobble, gravel, sand, and combinations thereof. The refractory material can define at least a portion of a melt boundary and should have a melting temperature greater than the waste-containing melt that it contains. In one embodiment, the refractory material has a melting temperature of at least approximately 100° C. greater than the melt. In addition to lining the container walls, melt barriers can be used to control the size and shape of a melt. For example, the melt barrier can be used to divide a container into a plurality of regions using appropriately-placed forms. In another example, the refractory material is used to round the bottom corners of the melt.

Typically, naturally-occurring earthen material comprises a mixture of complex metal oxides (minerals), for example, zirconia, magnesia, alumina, and iron oxides. The melting temperature of the melt barrier depends upon the composition of the earthen material, and in particular, the amount of refractory components present. For example, because silica melts at a very high temperature of 2876° F. (1580° C.), sands having a high silica content melt at much higher temperatures than sands having lower amounts of silica. For example, whereas pure silica sand melts at 2876° F., its melting temperature can be reduced to 1292° F. by adding 15% soda ash (Na₂CO₃) and 10% lime (CaO) by volume. Therefore, earthen materials must be appropriately-selected to be effective physical barriers to the melt, thereby preventing the melt from contacting the wall of the ICV container. Surprisingly, when using refractory sand, a viscous transition zone between the melt and the melt barrier served to support the sand “face,” and prevented the sand from flowing into the melt during processing. Furthermore, the thickness of the refractory can be designed to ensure that a minimum temperature is attained within the permeable refractory. If it is too thick, the temperature on the backside might not be great enough to destroy organics.

Absent naturally-occurring, high-silica-containing earthen materials, refractory components can be added to available earthen materials to increase the melting temperature of the melt barrier. For example, the melt barrier can further comprise at least one manufactured refractory material including, but not limited to thermal insulation board, refractory bricks, castable refractory concrete (e.g., KAOCRETE®), and combinations thereof. The castable refractory concrete can be utilized as cast panels. In some instances, the melt barrier can be permeable to gases generated during the ICV process. A non-limiting example of a gas-permeable melt barrier is a mixture of cobble and cast KAOCRETE, wherein the melt barrier was found to allow the passage of gas through void spaces between the cobble. Depending on the waste to be treated, permeability can be desirable, especially as a means of preventing melt disruptions by allowing gases generated during ICV to escape. In another embodiment, the release of gas can be facilitated by permeable channels constructed along the sides of the melt.

In another embodiment, the refractory lining and insulating material can be combined into a single layer. Many refractory materials are thermally-conductive, while many insulating materials do not have sufficiently high melting points. Therefore, refractory materials with high thermal conductivities can be made more insulating by the addition of insulating and/or porous materials. The refractory material can be castable, in which case the insulating material can be added while the refractory material is in fluid form. An example of a porous material that can be used to increase the insulating characteristics of a refractory material is pumice. Another example is hollow ceramic beads. Use of a combined refractory/insulating melt barrier can result in a simplified liner system for ICV. Furthermore, the insulating characteristics of the refractory can be improved by entraining air in the mix prior to setting, as in, for example, aerated refractories.

In yet another embodiment, the refractory layer can comprise the entire layer of thermally insulating material. The layer of refractory materials may comprise a mixture of cast refractory materials and granular refractory materials, or mixtures thereof. The refractory materials can both be solid or porous and have levels of permeability that either prevent or allow flow of gases or liquids through themselves.

In addition to the liner system, at least two electrodes or at least one heating element are placed within the box. The material to be treated can then be placed within the box and the melting process is conducted as described herein. Once melting is complete, the contents of the box are allowed to cool and solidify. Subsequently, the box is then disposed of along with the vitrified and/or crystallined contents. In an alternate embodiment, the vitrified and/or crystallined contents can be removed from the box and disposed of separately, thereby allowing the box to be re-used.

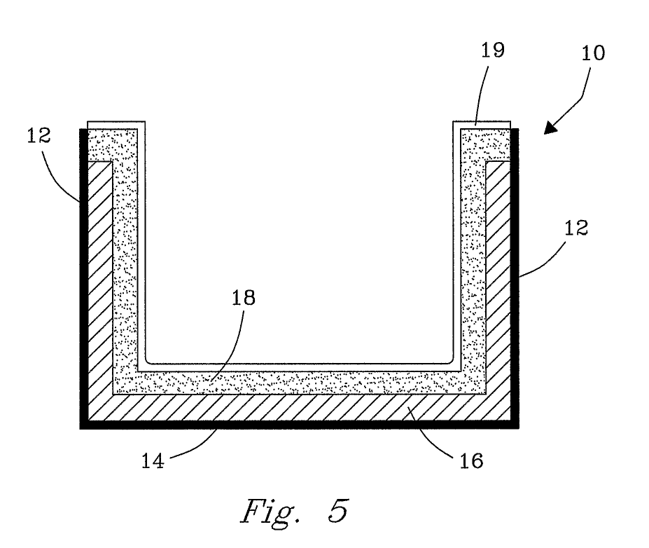

FIG. 5 illustrates a treatment container according to one embodiment of the present invention. As illustrated, the container 10 comprises a box having sidewalls 12 and a base 14. The container 10 is provided with either an air gap and/or a layer of insulation 16 on each of the sidewalls 12 and the base 14. Insulation 16 may be comprised of materials such as thermal insulation board, natural earthen materials, or any other material capable of impeding the flow of heat. After placement of the insulation, the container is lined with a refractory material 18. The refractory material is provided so as to line the sides as well as base of the container in all areas that may be exposed to the melt. In a preferred embodiment, when free liquids are used in connection with the invention, the refractory material may be further lined with a liquid impermeable liner 19, such as a plastic liner 19. Alternatively, the refractory material can be lined with absorbent materials such as vermiculite, absorbent clays and other absorbent minerals.

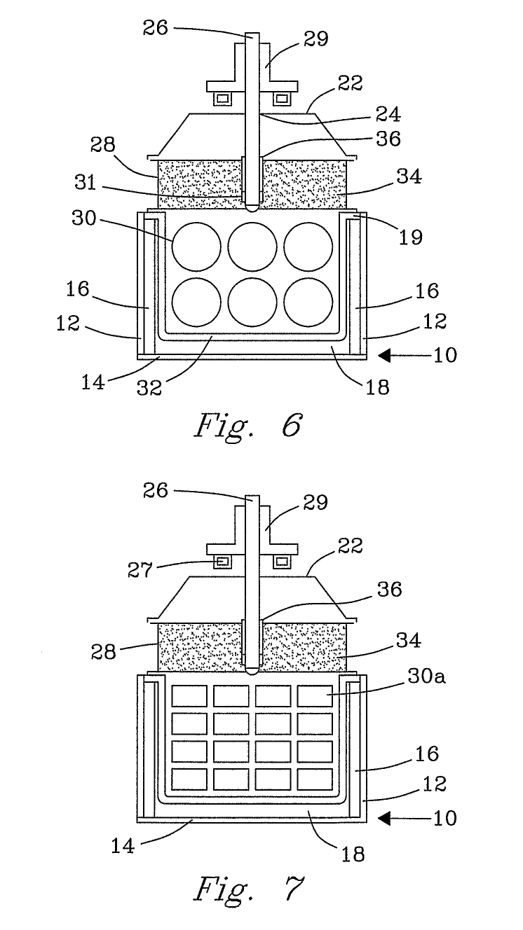

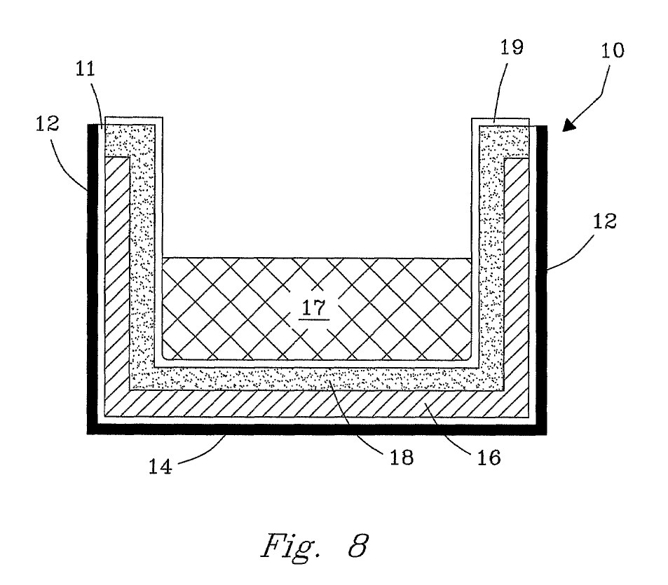

FIG. 6 illustrates one embodiment of the present invention. As shown, the container of FIG. 5 is provided with a lid or cover 22. The lid or cover 22 is positioned over the container 10 and seals the top thereof. The lid or cover is provided with openings 24 through which extend the electrodes or the heating element 26.

Between the lid or cover 22 and the container 10, may be placed a connector 28, which connects the lid or cover 22 to the container 10.

As indicated in the example shown in FIG. 6, after the insulation 16 and refractory material 18 are placed in the container 10, the material to be treated 30 is then placed within the container. For example, if drums are used in connection with the present invention, the drums may comprise standard 55 or 30 gallon drums. It should be understood, however, that there is no limitation on the size of the drum or container used with the present invention. Void spaces between the drums 30 are filled with soil 32. Such soil, 32, is also provided to cover the drums. Further, a layer of cover soil 34 is placed over the covered drums and extends into the connector 28. An electrode or heating element placement tube 36 extends through the cover soil 34. The electrodes or heating element 24 for the treatment process extend through the placement tube 36.

FIG. 7 illustrates another exemplary embodiment of the invention wherein compacted drums 30 or any other materials to be treated are provided in the container 10 instead of cylindrical drums as shown in FIG. 6.

### ICV Container—Thermal Liner Design

In another embodiment, a liner system for in-container vitrification comprises a treatment vessel, or container, having a inner and outer wall wherein the inner wall defines a void therein, a layer of thermally insulating material such as DynaGuard™ Board in contact with the inner wall of the treatment vessel, a layer of refractory such as FIREFLY® REFRACTORY PRODUCTS materials bounded by the layer of thermally insulating material; and a layer of melt material in thermal contact with the layer of refractory material wherein the layer of refractory material is interposed between the layer of thermally insulating material and layer of melt material. The invention also contemplates having annulus between the inner wall of the treatment vessel and layer of insulation to facilitate the dissipation of the heat from the entire melting process. In this embodiment the annulus can form a flow channel having at least one inlet and at least one outlet. Air, liquid and other cooling gases or liquids can enter the inlet at a first temperature and exit out the outlet at a second temperature. Generally the temperature at the inlet is lower than the temperature at the outlet.

In a still further embodiment, the treatment vessel may be a typical industrial roll-off box which may be purchased from such vendors as Dewalt Northwest and the CRW Group. It is also advantageous that the treatment vessel have at least one removable side wall to enable easy removal of the solidified melt product after completion of processing. This objective may be achieved by having a treatment vessel that has at least one side wall which is pivotally hinged to allow the treatment vessel to partially open to facilitate a slower drain of the melt. In still another embodiment, the treatment vessel has at least one side wall with a removable portion that can be removed to allow draining of the melt from the treatment vessel. Such removable portion could be varied in size to achieve different melt draining rates. The removable portion could be replaced to enable reuse of the treatment vessel.

FIG. 8 illustrates a treatment vessel according one embodiment of the present invention. As illustrated the treatment vessel comprises a typical 25 cubic yard “roll-off” box having sidewall 12 and a base 14. The layer of insulation 16 may be comprised of carbon based materials, graphite based materials, sand, bricks, concrete, or thermal insulation board, a mixture thereof or any other materials having a high melting point. After placement of the insulation, the treatment vessel is lined with a refractory material 18. The refractory material is provided so as to line the sides and base of the insulation layer. The layer of refractory material may also substitute for the layer of insulation when deposited in adequate thickness. The melt material 17 to be treated is then placed in thermal contact with the refractory materials. In another embodiment, when free liquids are used in connection with the invention, the refractory material may be further lined with a liquid impermeable liner 19, such as a plastic liner 19. Such treatment vessels, as described herein, may have any variety of dimensions of length, width and height. However, as will be appreciated by persons skilled in the art, the volume and dimensions of the box will be limited only by the requirements of any apparatus that must be attached thereto. One skilled in the art would recognize that a cover may be positioned over the treatment vessel. Such a cover may be fitted with openings through which to extend the electrode, to withdraw gases generated during processing, and to feed materials into the treatment vessel/treatment vessel during and after processing.

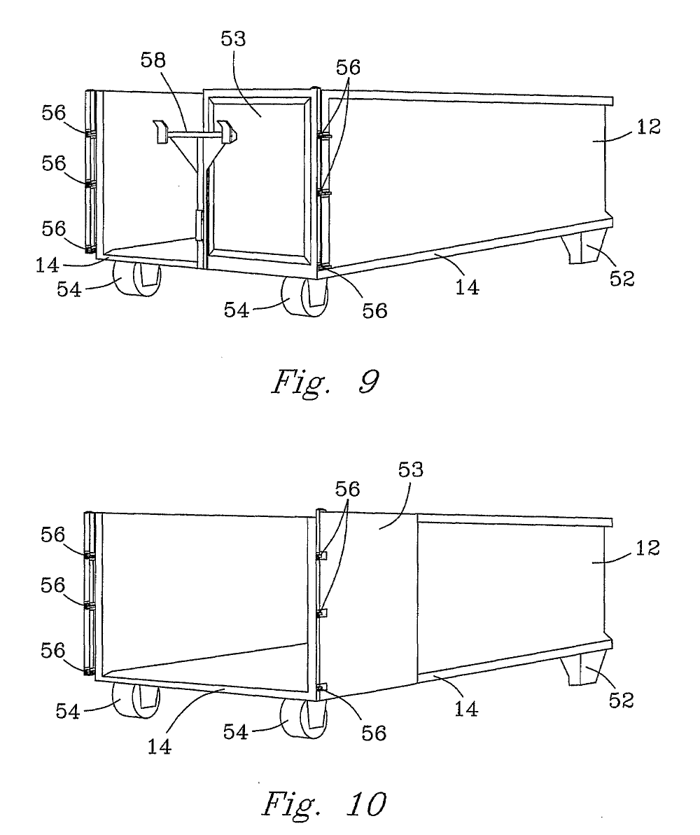

It is also advantageous that the treatment vessel have at least one removable side wall to enable easy removal of the solidified melt product after completion of processing. The side wall may also be pivotally hinged to allow for partial or complete opening. FIG. 9 illustrates a treatment vessel that has at least one sidewall which is pivotally hinged to allow the treatment vessel to partially open to facilitate a slower a slower drain of the melt. The treatment vessel a typical “roll-off box” having a sidewall 12 and a base 14. Tapered skids 52 provide added strength and minimization of debris build up. Wheels 54 allow for easy maneuvering. In this embodiment a side wall 53 comprising of two sections are held together by a typical T-latch 58. Hinges 56 placed vertically along the edges of both section to securing attached side wall 53 to side wall 12 and allow the each section of side wall 53 to open independently of the other section. Three vertical corner hinges 56 allow the treatment vessel side wall 53 to pivotally open for disposal of the melt material. A T-latch 58 door release allows section of side wall 53 to safely close and lock.

FIG. 10 illustrates another embodiment of the present invention, wherein the sidewall 53 may be completely open to allow for easy disposal of the melt material. One skilled in the art would recognize that either or both sections of the side wall 53 can be removed by removing the hinges 56. Such removable portion could be varied in size to achieve different melt draining rates. The removable portion could be replaced to enable reuse of the treatment vessel.

### In-Container Vitrification Methods

The present invention will now be described in terms of the steps performed. First, the containers, as described herein, can be lined with a thermal insulation board, followed by placement of a slip form to facilitate the installation of a layer of refractory material. Alternatively, an earthen material having refractory qualities can serve alone as a melt barrier. A liquid-impermeable liner can be placed in the container so that materials to be treated and soil can be staged within the liquid impermeable liner. The liquid impermeable liner may be used to contain liquids prior to treatment when the material to be treated contains appreciable liquids. The slip form may be removed once the material to be treated is emplaced.

As described below in the example, the material to be treated can be placed within the container in drums. Within the drums, the material to be treated can be compacted to maximize the amount of the material to be treated. Alternatively, in another embodiment, the material to be treated can be placed directly into the container without the need for drums. In another embodiment, the material to be treated can be placed within the container in bags or boxes. In still another embodiment, liquid wastes can be mixed with soil or other absorbents and placed in the container.

As will be appreciated by persons skilled in the art, various additives may be added to the material to be treated to improve or enhance the process of the invention. For example, glass-modifying agents, may increase the conductivity of the material to be treated (e.g. Na⁺) or aid in oxidizing metals contained in the material to be treated (e.g., sucrose or KMn0₄). Other agents, such as process-modifying agents, may be used including additives to improve the durability of the vitrified and/or crystalline mass (i.e., the solidified material) or chemicals added to enhance the destruction of chlorinated organics such as PCBs. Additionally, additives may affect melt temperature by raising or lowering the melt temperature.

The additives may be introduced as purified materials or they may already be present in a particular earthen material, which can be added to the material to be treated. Examples of glass-modifying agents can comprise fluxing agents, colorizers, opacifiers, stabilizers, and combinations thereof. A fluxing agent can include, but is not limited to sodium carbonate, potassium carbonate, sodium sulfate, glass cullet, and combinations thereof. Examples of colorizers can include metal oxides, and specifically oxides of copper, chromium, manganese, iron, cobalt, nickel, vanadium, titanium, neodymium, praseodymium and combinations thereof. Additional colorizers can comprise precipitations of precious metal colloids and of selenium, cadmium sulfide, and cadmium selenide. Opacifiers can comprise fluorine-containing materials, phosphates, or combinations thereof. Stabilizers can give glass physical and chemical properties such as chemical resistance and/or mechanical strength that are important for its usability. Examples of stabilizers can include CaO, Al₂O₃, CaCO₃, alkali-containing feldspars, lead oxides, BaO, BaCO₃, B₂O₃, H₃BO₃, ZrO₂, Li₂O, K₂O, MgO, TiO₂, and combinations thereof.

In a preferred embodiment, the containers of the present invention can be standard “roll off” boxes ranging in volume from 10 to 40 cubic yards. Such containers or boxes may have any variety of dimensions of length, width and height. However, as will be appreciated by persons skilled in the art, the volume and dimensions of the box will be limited only by the requirements of any apparatus that must be attached thereto. In another embodiment, the container of the invention may comprise metal drums, such as standard 55 gallon steel drums. Such drums can be provided with the required insulation and/or refractory material layers as discussed herein. The wall thickness of the containers of the invention can also vary. Typically, standard boxes have wall thicknesses that are in the range of 10 to 12 gauge; however, other dimensions are possible.

In general terms, the insulation and refractory materials can form a melt barrier in the interior of the container. The liner serves to contain the melt and maintain the heat within the container so as to increase the efficiency of the melting process. It also serves to keep the melt from contacting the container, which could cause the container to fail. A sufficiently thick layer of refractory material can eliminate the need for an insulating layer. Alternatively, the refractory material may be omitted and only an insulating layer provided in the container, if such insulating material is refractory enough to not melt during processing. In the case where both a refractory layer and separate insulating layer are used, the refractory material would also serve to slow down the transfer of heat to the insulating layer. In such a case, it would be possible to extract the insulating layers from the container after the melting process and re-use them. In another embodiment, multiple layers of insulating and/or refractory liners may be used. As will be understood, the amount of insulating and/or refractory material would depend, amongst other criteria, on the nature of the soil and materials being treated. For example, if such soil and material to be treated has a high melting temperature, then extra insulating and/or refractory material may be required. Alternatively, as mentioned above, the insulating and refractory materials can be combined in a single melt barrier.

In some instances, it can be advantageous to stabilize a loose-material melt barrier into a rigid monolithic form. This can be especially true of vertical walls. Pre-forming sections of the melt barrier can increase efficiency relative to constructing slip forms inside each ICV container. Therefore, the present invention encompasses the addition of a material that can act as a binder with the earthen material. Examples of such a material can include, but are not limited to waterglass or carbon paste. Waterglass comes in fluid form and can cure upon contact with CO₂ in the air to a hardened form. It typically comes as sodium silicate or potassium silicate, with potassium silicate being more refractory. Both silicates can soften at high temperatures, but the material would have served its purpose of providing rigidity during handling and construction of the liner system. In one embodiment, the waterglass can infiltrate a refractory sand that has been placed in a form having the desired shape and dimensions. Once the sand/waterglass mixture hardens, the solidified melt barrier can be handled and placed in the ICV container. An alternative application technique comprises trowelling the fluid binder/earthen material mixture onto the appropriate surfaces. Carbon paste can be utilized in a similar fashion. Carbon paste (graphite) can be advantageous because it has a very high melting temperature and is typically not wetted by soil melts. Thus, it makes an excellent refractory material to be in direct contact with the waste-containing melt. In addition, the use of carbon-based material enables use of the material layer to serve as an electrode to enhance processing.

The present invention is not limited to remediation of already-contaminated materials or soils, but also encompasses treatment of waste products. For example, the waste product can be, but is not limited to a waste stream from an industrial process or waste stored in barrels or tanks. The waste product can be liquid, solid, or a mixture of both. A method for treating such waste products by ICV can comprise mixing earthen material, glass frit, and/or glass cullet with a waste product, thereby forming a material to be treated; charging an ICV container with the material to be treated, melting the material to be treated, and cooling the container having the melted material to be treated. The earthen material and the waste product can be dried, for example, using heat or dry gas. The container having the material to be treated should also contain electrodes, which are electrically connected to at least one power supply, and at least one starter path each electrically connecting at least two of the electrodes.

In one embodiment, the earthen material, which can comprise soil, and liquid-containing waste products are transferred into a vessel where the two materials can be mixed and dried. Drying can be achieved by heating the materials and/or by blowing dry gases through them, employing standard industrial drying processes and equipment. The material to be treated can then be transferred to an ICV container for vitrification as described and claimed herein. The earthen material can comprise sand, silt, clay, sediment, gravel, cobble, rock, boulders, or combinations thereof, and typically contains oxide materials and/or silicates. As described herein, the composition of the earthen material and, therefore, the material to be treated, influences the properties of the melt and the final vitrified product. While the waste-treatment requirements may vary depending on the particular application, in one embodiment, the present invention encompasses clean earthen materials having at least about 30 wt % non-earthen waste materials.

The waste product can comprise Comprehensive Environmental Response, Compensation, and Liability Act (CERCLA) wastes, Resource Conservation and Recovery Act (RCRA) wastes, radioactive wastes, transuranic (TRU) wastes, high-level wastes, low-level wastes, mixed wastes, organic wastes, inorganic wastes, high-sodium bearing wastes, metals, heavy metals, contaminated materials, or combinations thereof. Organic wastes can include, but are not limited to volatile organics, semi-volatile organics, polyaromatic hydrocarbons, chlorinated organics, and combinations thereof. Examples of organic wastes include, but are not limited to, benzenes, acetones, toluenes, phenols, napthalenes, pyrenes, fluoranthenes, anthracenes, phenanthrenes, chrysenes, anilines, alcohols, and combinations thereof. Examples of chlorinated organics include, but are not limited to, PCBs, dioxins, chlorinated furans, chlorinated phenols, pentachlorophenol, hexachlorobenzene (HCB), hexachloroethane, hexachlorobutadiene, chlorinated pyrroles, chlorinated thiophenes, or combinations thereof. Radioactive wastes can include, but are not limited to radionuclides selected from the group consisting of technetium, Tc-99, Cs-137, Am-241, Co-60, I-129, I-131, Sr-90, radon, radon-220, H-3, radium-238, Th-232, Th-230, Th-228, U-234, U-235, U-238, depleted uranium, Pu-238, Pu-239, Pu-240, Pu-241, and combinations thereof. Examples of metals can include, but are not limited to beryllium, arsenic, chromium, cadmium, silver, nickel, and selenium, and combinations thereof, while examples of heavy metals can include, but are not limited to lead, barium, mercury, radium, and combinations thereof. Alternatively, heavy metals can comprise metals having an atomic weight greater than or equal to about 200 atomic mass units. Inorganic compounds can comprise materials selected from the group consisting of cyanide, nitrates, nitrites, sulfates, sulfites, carbonates, chlorides, fluorides, other halides, and combinations thereof.

The waste product can comprise less than or equal to about 70 wt % high-sodium bearing waste, for example, Na₂O. The maximum amount of high-sodium bearing wastes can be determined by the conductivity of the material to be treated. As is true of most conductive waste products, large amounts of sodium-bearing wastes can increase the conductivity of the material to be treated. In one embodiment, the conductivity of the material to be treated should be less than that of the starter path. Waste products having higher sodium concentrations can be blended down prior to loading in the ICV apparatus.

The present invention also encompasses treatment of pesticides, insecticides, herbicides, fungicides, and combinations thereof. Pesticides can include, but are not limited to DDT, DDD, DDE, Chlordane®, Methoxychlor®, Heptachlor®, heptachlor epoxide, Dieldrin®, Endrin®, Aldrin®, Lindane®, BHC, endosulfans, or combinations thereof. Examples of insecticides can include antibiotic, macrocyclic lactone, avermectin, milbemycin, arsenical, botanical, carbamate, benzofuranyl methylcarbamate, dimethylcarbamate, oxime carbamate, phenyl methylcarbamate, dinitrophenol, fluorine, formamidine, fumigant, inorganic, insect growth regulators, chitin synthesis inhibitors, juvenile hormone mimics, juvenile hormones, moulting hormone agonists, moulting hormones, moulting inhibitors, precocenes, unclassified insect growth regulators, nereistoxin analogue, nicotinoid, nitroguanidine, nitromethylene, pyridylmethylamine, organochlorine, cyclodiene, organomercury, organochlorine, organophosphorus, organiothiophosphate, aliphatic organothiophosphate, aliphatic amide organothiophosphate, oxime organothiophosphate, heterocyclic organothiophosphate, benzothiopyran organothiophosphate, benzotriazine organothiophosphate, isoindole organothiophosphate, isoxazole organothiophosphate, pyrazolopyrimidine organothiophosphate, pyridine organothiophosphate, pyrimidine organothiophosphate, quinoxaline organothiophosphate, thiadiazole organothiophosphate, triazole organothiophosphate, phenyl organothiophosphate, phosphonate, phosphonothioate, phenyl ethylphosphonothioate, phenyl phenylphosphonothioate, phosphoramidate, phosphoramidothioate, phosphorodiamide, oxadiazine, phthalimide, pyrazole, pyrethroid, pyrethroid ester, pyrethroid ether, pyrimidinamine, pyrrole, tetronic acid, thiourea, urea, unclassified, and combinations thereof. Herbicides can comprise antibiotic herbicides, aromatic acid herbicides, benzoic acid herbicides consisting of amide, anilide, arylalanine, chloroacetanilide, sulfonanilide, pyrimidinyloxybenzoic acid, phthalic acid, picolinic acid, quinolinecarboxylic acid, arsenical, benzoylcyclohexanedione, benzofuranyl alkylsulfonate, carbamate, carbanilate, cyclohexene oxime, cyclopropylisoxazole, dicarboximide, dinitroaniline, dinitrophenol, diphenyl ether, nitrophenyl ether, dithiocarbamate, halogenated aliphatic, imidazolinone, inorganic, nitrile, organophosphorus, phenoxy, phenoxyacetic, phenoxybutyric, phenoxypropionic, aryloxyphenoxypropionic, phenylenediamine, pyrazolyloxyacetophenone, pyrazolylphenyl, pyridazine, pyridazinone, pyridine, pyrimidinediamine, quaternary ammonium, thiocarbamate, thiocarbonate, thiourea, triazine, chlorotriazine, methoxytriazine, methylthiotriazine, triazinone, triazole, triazolone, triazolopyrimidine, uracil, urea, phenylurea, sulfonylurea, pyrimidinylsulfonylurea, triazinylsulfonylurea, thiadiazolylurea, unclassified, or combinations thereof.

The waste product can also comprise nitrates, nitrites, and high- or low-level wastes, such as those of heavy metals, actinides, radioactive wastes and combinations thereof.

In one embodiment of the present invention, the waste product can be taken directly from the waste stream from an industrial process. In such an instance, the waste product, which may be a liquid, can be transferred in barrels, tanks, or pumped directly to a treatment facility for mixing with earthen material as described by the present invention.

### EXAMPLE

### Uranium Chips in the Presence of Oil

The invention will now be described with reference to a specific example wherein radioactive substances, such as uranium chips in the presence of oil, are involved. It will be understood that the example is not intended to limit the scope of the invention in any way.

First, the material to be treated is placed within 30 gallon drums. The drums, containing the material to be treated, are then compressed or compacted and placed within 50 gallon drums and packed with soil and sealed. These latter drums are then introduced into the treatment container 10. During the compression of the smaller drums, any oil in the material to be treated may need to be removed and treated separately, as described further below.

The placement of the compacted drums of material to be treated (e.g., uranium and oil) into the container 10 can be performed in two ways. The first method involves emptying of the 55-gal drums holding the compacted smaller drums and soil into the container 10. The compacted drums would be immediately covered with soil to prevent free exposure to air. In this method, the compacted drums may be staged more closely together for processing, and a higher loading of uranium can be achieved. In addition, by removing the compacted drums from the 55-gal drums, there would be no requirement to ensure that the 55-gal drums were violated or otherwise unsealed so as to release vapors during the melting phase.

Alternatively, the 55-gal drums containing the compacted drums could be placed directly into the waste treatment containers for treatment. In this case, vent holes will be installed into the drums to facilitate the release of vapors during processing.

Some of the contaminated oil removed during the compression phase of the smaller (30 gallon) drums can be added to the soil in the treatment volume in the container for processing with the drums of uranium. The liquid impermeable liner 19 will prevent the movement of free oil from the materials to be treated into the refractory sand materials 18. The slip form will be raised as the level of waste, soil, and refractory sand are simultaneously raised, until the container is filled to the desired level. At that point the slip form will be removed to a storage location.

A layer of clean soil is placed above the staged waste and refractory sand. Electrodes are then installed into the soil layer. The installation of the electrodes may involve the use of pre-placed tubes to secure a void space for later placement of electrodes 26. Alternatively, the pair of electrodes are installed in the staged waste and refractory sand prior to the layer of clean soil being placed above the staged waste and refractory sand. A starter path is then placed in the soil between the electrodes. Lastly, additional clean cover soil 34 is placed above the starter path 31. This will conclude the staging of the waste within the treatment container. The configuration of the waste treatment containers after waste staging is shown in FIGS. 6 and 7.

Once the waste treatment container 10 is staged with waste as described above, it is covered with an off-gas collection hood 22 that is connected to an off-gas treatment system. Electrode feeder support frames 27, to support electrode feeders 29, are then positioned over the container-hood assembly 22 unless they are an integral part of the hood 22 design, in such case they will already be in position. At least two electrodes 26 are then placed through the feeder 29, into the hood 22 and into the tube 36 placed at the end of the starter path 31. Additional starter path material will be placed within the tube 36 to ensure a good connection with the starter path 31. Finally the remainder of the tube will be filled with clean cover soil 34. This will complete the preparation of materials for melting. It will be appreciated that although the above discussion has been directed to at least two electrodes, it will be apparent to persons skilled in the art that at least one heating element may also be used with the system.

Commencement of off-gas flow and readiness testing will be performed prior to initiation of the melting process. The melt processing will involve application of electrical power at an increasing rate (start-up ramp) over a period of time and at a given power output value. For example, electrical power may be applied for about 15 hours to a full power level of approximately 500 kW. It is anticipated that processing of waste containing uranium, drums and oil may take a total of two (2) to five (5) days cycle time to complete depending on the type of waste being treated, the power level being employed and the size of the container. Preferably, processing will be performed on a 24-hr/day basis until completed.

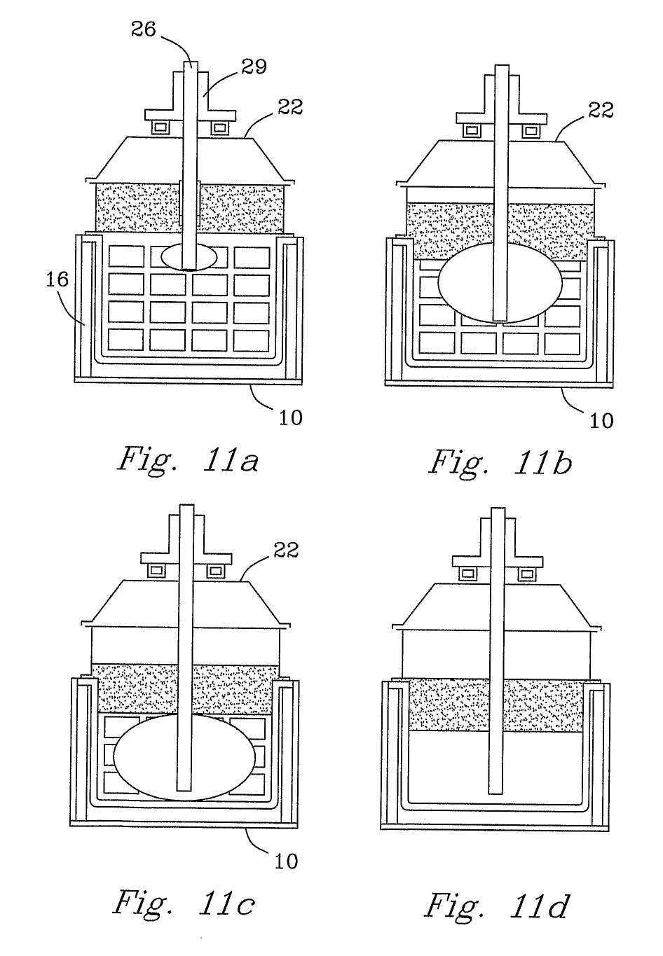

FIGS. 11a to 11d illustrate the progressive stages of melting of the material within the container 10.

Although the invention has been described with reference to certain specific embodiments, various modifications thereof will be apparent to those skilled in the art without departing from the spirit and scope of the invention as outlined in the claims appended hereto.

We claim:

1. A melt barrier comprising an earthen material having a melting point greater than a waste-containing melt wherein the earthen material is selected from the group consisting of rock, cobble, gravel, sand, and combinations thereof, and wherein said melt barrier defines at least a portion of a melt boundary for in-container vitrification.

2-3. (canceled)

4. The melt barrier as recited in claim 1, wherein the earthen material comprises refractory components selected from the group consisting of silica, zirconia, magnesia, alumina, and combinations thereof.

5-10. (canceled)

11. The melt barrier as recited in claim 1, wherein said melt barrier is permeable to gases generated during an ICV process.

12-19. (canceled)

20. The melt barrier as recited in claim 1, further comprising an insulating material comprising a porous material.

21. The melt barrier as recited in claim 20, wherein said porous material comprises pumice.

22. The melt barrier as recited in claim 1, further comprising an insulating material wherein a mixture of said insulating material and said earthen material has a reduced thermal conductivity relative to said earthen material.

23-24. (canceled)

25. The melt barrier as recited in claim 20, further comprising a refractory sand having a melting point greater than a waste-containing melt, wherein the melt barrier lines inner walls of a roll-off box used for in-container vitrification and wherein the insulating material comprises pumice.

26-28. (canceled)
